(19) United States
(12) Patent Application Publication
(10) Pub. No.: US 2023/0421582 A1
(43) Pub. Date: Dec. 28, 2023

(54) CYBERSECURITY OPERATIONS CASE TRIAGE GROUPINGS

(71) Applicant: Revelstoke Security, Inc., Campbell, CA (US)

(72) Inventors: Joshua McCarthy, Morgan Hill, CA (US); David B McKinley, Dartmouth, MA (US); Lance Rund, San Jose, CA (US)

(73) Assignee: Revelstoke Security, Inc., Campbell, CA (US)

(21) Appl. No.: 18/243,736

(22) Filed: Sep. 8, 2023

Related U.S. Application Data
(63) Continuation-in-part of application No. 17/825,024, filed on May 26, 2022.
(60) Provisional application No. 63/530,726, filed on Aug. 4, 2023.
(60) Provisional application No. 63/471,278, filed on Jun. 6, 2023.
(60) Provisional application No. 63/451,249, filed on Mar. 10, 2023.
(60) Provisional application No. 63/404,983, filed on Sep. 9, 2022.
(60) Provisional application No. 63/327,853, filed on Apr. 6, 2022.
(60) Provisional application No. 63/297,273, filed on Jan. 7, 2022.
(60) Provisional application No. 63/274,302, filed on Nov. 1, 2021.
(60) Provisional application No. 63/234,729, filed on Aug. 19, 2021.
(60) Provisional application No. 63/193,615, filed on May 27, 2021.

(51) Int. Cl. H04L 9/40; H04L 41/16

(52) U.S. Cl. CPC H04L 63/1416; H04L 63/1425; H04L 41/16

(57) ABSTRACT

Disclosed techniques include cybersecurity operations case triage groupings. A plurality of network-connected cybersecurity threat protection applications is accessed. A plurality of inputs is received from the cybersecurity threat protection applications. The plurality of inputs is initiated by one or more cybersecurity events. A computer platform is used to analyze metadata associated with the plurality of inputs from the cybersecurity threat protection applications. The analyzing is based on parsing incoming traffic alerts from the cybersecurity threat protection applications. The inputs are triaged into groupings, based on the metadata. The triaging determines commonality of threats among the plurality of inputs. The groupings are based on a number of users experiencing the plurality of inputs. The number of users is matched against a threshold for the plurality of inputs and a particular grouping. A cybersecurity threat response is generated, based on the groupings. The cybersecurity threat response addresses a zero-day event.

### RELATED APPLICATIONS

This application claims the benefit of U.S. provisional patent applications “Cybersecurity Operations Case Triage Groupings” Ser. No. 63/404,983, filed Sep. 9, 2022, “Cybersecurity Operations Mitigation Management” Ser. No. 63/451,249, filed Mar. 10, 2023, “Cybersecurity AI-Driven Workflow Generation Using Policies” Ser. No. 63/471,278, filed Jun. 6, 2023, “Cybersecurity AI-Driven Workflow Modification” Ser. No. 63/530,726, filed Aug. 4, 2023.

This application is also a continuation-in-part of U.S. patent application “Cybersecurity Threat Management Using Element Mapping” Ser. No. 17/825,024, filed May 26, 2022, which claims the benefit of U.S. provisional patent applications “Cybersecurity Threat Management Using Element Mapping” Ser. No. 63/193,615, filed May 27, 2021, “Cybersecurity Threat Management Using Impact Scoring” Ser. No. 63/234,729, filed Aug. 19, 2021, “Integrated Cybersecurity Threat Management” Ser. No. 63/274,302, filed Nov. 1, 2021, “Cybersecurity State Change Buffer Service” Ser. No. 63/297,273, filed Jan. 7, 2022, and “Cybersecurity Workflow Management Using Autodetection” Ser. No. 63/327,853, filed Apr. 6, 2022.

Each of the foregoing applications is hereby incorporated by reference in its entirety.

### FIELD OF ART

This application relates generally to cybersecurity management and more particularly to cybersecurity operations case triage groupings.

### BACKGROUND

From the beginning of the computer age, security for information technology has been a necessary concern. Since much of the early work on computer systems was done during World War II in order to decipher enemy communications, the need for security was all but assumed. In the 1940s, computer security was primarily concerned with protecting computers against physical access by unauthorized individuals or groups. Computers were large, sometimes filling entire rooms. They had specialized power and environmental requirements. Programming and operating a computer required direct access. A computer could only execute one program at a time and required a specialized operator to load the program, execute it, and interpret the results. Computer use was limited to those with specialized knowledge. Someone wanting to do harm to the computer itself or to use the computer for illegitimate or illegal purposes needed physical access, as well as the ability to program and operate the computer. Thus, security was focused on guarding the computer components and the environment required to run them.

As computer science and systems progressed, the ability to load and run programs became easier. While the physical components were still large and required environmentally controlled spaces, operating software and hardware soon allowed designers and programmers to input programs using punch cards, magnetic tapes, and disks that could feed data into the computers faster and more reliably. Computer components grew in speed and capacity and eventually led to the development of time sharing and a network of wired access points. Several users could access a computer concurrently as the operating system moved from one user to the next in turn, executing their programs, storage requests, and so on. Users could type in commands and programs using keyboards. Soon after, monochrome screens in green or amber were available, replacing reems of paper and allowing the users to immediately see what they had typed, and to read the responses from the computer system. Security for these computers became more complex as well. Physical security was still a major concern, but as wired access points and output devices such as magnetic tape drives and printers became more widely dispersed, control of these input and output points became as important as the location of the main computer components. Operating systems added usernames and passwords to ensure that those using the computer were authorized to do so. As the number of users increased, and the specialized knowledge required to interact with computer systems lessened, greater attention was paid to ensuring that the computer users were performing their duties correctly and appropriately. Security applications were created to control which users had access to specific levels of the computer system, and what data was available to them. Specialists who could manage hardware and software security began to appear.

In more recent times, computer networks and access points have proliferated many thousands of times. The Internet can now link users and computer systems from across the globe with one another. As the number of users and systems has expanded, the need for computer security has mushroomed as well. People with no background in computer science or even a basic understanding of computer systems now have access to massive amounts of data and processing power. Mobile devices such as cell phones, tablets, pads, and game platforms can be used to wirelessly access multiple computers simultaneously. Unfortunately, as computing power and access has grown, cybercrime has grown along with it. Financial systems can be compromised; individual users, families, and small business can be exploited; infrastructure systems can be wrecked; and public and private information stolen. As the number and types of malicious and accidental security breaches have grown, so our need for cybersecurity has exploded. Our continued reliance on computer systems of all types makes it inevitable that businesses, governments, and individual users will continue to face computer security challenges for many years to come.

### SUMMARY

To organizations of all sizes, the continuous operation of information technology (IT) infrastructure is mission critical. Indeed, successful organizational operations are inexorably linked to the effective IT and computing infrastructure. The computing operations are enabled by effective detection, diagnosis, management, and mitigation of cybersecurity threats of all types. All organizations are impacted by cybersecurity threats. These organizations include businesses, financial institutions, hospitals, government agencies, retailers, universities, and schools, among many others. The organizations are profoundly aware of the broad spectrum of cybersecurity threats that are maliciously directed toward them. IT sectors within the organizations actively configure, implement, and deploy state-of-the art cybersecurity hardware and software with the objective of securing their IT infrastructure against the threats. While routine, preventative measures such as installing updates to application and operating systems software, deactivating accounts of former users, and performing security (“white hat”) checkups and other housekeeping activities are common to successful IT operations, these measures alone are inadequate to provide comprehensive IT infrastructure protection. The cybersecurity threats evolve rapidly and continue to become significantly more sophisticated. Thus, constant system-wide vigilance and anticipatory action are demanded. Nearly as soon as a cybersecurity solution is found that identifies, responds to, and eradicates a threat such as a virus; thwarts a Trojan horse program; or detects and deletes a phishing attack; the malefactors behind the cybersecurity attacks adapt their techniques by using new attack vectors; advanced social engineering ploys; hacking; data theft; and many other deceptive, malicious, and illegal techniques.

Disclosed techniques enable cybersecurity operations case triage groupings. A plurality of network-connected cybersecurity threat protection applications is accessed. The cybersecurity threat protection applications can include endpoint protection, anti-phishing and antivirus applications, firewalls, “man-in-the-middle” detection, denial-of-service (DoS) and distributed denial-of-service (DDoS) detection, ransomware detection, and so on. A plurality of inputs is received from the cybersecurity threat protection applications. The plurality of inputs is initiated by one or more cybersecurity events. The cybersecurity events can include attacking on one or more devices, locking out users, corrupting software and operating systems, ransoming data, and the like. A computer platform is used to analyze metadata associated with the plurality of inputs from the cybersecurity threat protection applications. The metadata can include status information and other information associated with a type of a detected cybersecurity threat. Other metadata can include a time and a frequency of cybersecurity threat protection application inputs, techniques used to receive the application inputs, which tool provided the application inputs, who was operating a tool or device that initiated the input, etc. The inputs are triaged into groupings, based on the metadata. The triaging can be used to detect types of attacks, such as “zero-day” attacks, to determine whether the inputs are associated with a true positive attack, etc. A cybersecurity threat response is generated, based on the groupings. A generated response can include starting a workflow process to address the threat. The generated response can further include initiating a device or access lockdown, commencing a threat eradication procedure, and so on.

A computer-implemented method for cybersecurity management is disclosed comprising: accessing a plurality of network-connected cybersecurity threat protection applications; receiving a plurality of inputs from the cybersecurity threat protection applications, wherein the plurality of inputs is initiated by one or more cybersecurity events; analyzing, on a computer platform, metadata associated with the plurality of inputs from the cybersecurity threat protection applications; triaging the inputs into groupings, based on the metadata; and generating a cybersecurity threat response, based on the groupings. In embodiments, the groupings are based on a number of users experiencing the plurality of inputs. In embodiments, the number of users is matched against a threshold for the plurality of inputs. In embodiments, the threshold is based on a particular grouping. In embodiments, the threshold is set recursively for a particular grouping. And in embodiments, the analyzing is based on parsing incoming traffic alerts from the cybersecurity threat protection applications.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for cybersecurity operations case triage groupings.

FIG. 2 is a flow diagram for triaging groupings.

FIG. 3 is a system block diagram for cybersecurity operations case triage groupings.

FIG. 4 illustrates a cloud-connected security orchestration, automation, and response (SOAR) system.

FIG. 5A shows an example neural network for machine learning.

FIG. 5B illustrates training a neural network for machine learning.

FIG. 6 is a flow diagram for cybersecurity workflow management.

FIG. 7 is a system diagram for cybersecurity operations case triage groupings.

### DETAILED DESCRIPTION

The information technology (IT) infrastructures of various enterprises are the targets of essentially constant attacks. These infrastructures are the targets of hackers, spammers, confidence tricksters, and all manner of criminals who are hiding onshore, offshore, or even within the enterprises themselves. These outlaws include individual criminals, gangs, and organized crime; expert hackers sponsored and protected by enemy and rogue governments; and terrorists and extortionists; among many others with malicious intent. The constant attacks are directed at businesses, government agencies, hospitals, research laboratories, retailers, universities, and other enterprises and organizations. Data shows that cybersecurity threats such as cyberattacks, phishing expeditions, and attempted data theft or destruction have been detected to occur as often as every few seconds. By far the most frequently targeted enterprises include those from sectors such as high technology, retail, and government agencies including defense, air traffic control, and revenue. These sectors, sometimes referred to as the “big three”, are attacked because of their high-value data and their potential to execute large financial payouts. Other high-value targets include media companies who are called out by cyberattackers for allegedly insulting a religion or humiliating national leaders. Further, national infrastructures such as pipelines and energy grids are targets because of the disruption which would be caused by their being disabled or interrupted.

Small businesses and individuals are not immune from cybercriminal attacks, despite their diminutive sizes and relatively small potential payout capabilities. The smaller enterprises and the individuals are targets for small, quick payouts and for identity theft. Fuel and energy infrastructures are attacked because of the potential to cause both huge energy delivery disruptions and financial market chaos. Small enterprises in particular, which tend to have limited cybersecurity threat protection capabilities, have been willing to pay any amount they can to recover their business data from cybercriminals who have maliciously encrypted the enterprises' data. An individual may freely and unwittingly provide usernames and passwords associated with bank or brokerage accounts; personal information such as telephone numbers, email addresses, physical addresses, age, gender, birthdate, national identification number, and so on to the cybercriminals without realizing they have been defrauded by doing so. Stolen personal information has been used to open bank accounts, to obtain credit cards or loans, and to execute other actions such as performing online crimes which can ruin the individual's financial wellbeing, credit score, and more. The individual may also drain their personal savings or run up substantial personal debt to transfer funds to what turns out to be an offshore financial institution, thinking they are providing aid to a friend or loved one in distress or legal trouble.

Enterprises of all sizes attempt to protect themselves against cybersecurity threats by annually expending significant financial and human resources. Cybersecurity activities such as cybersecurity threat management are designed to protect computing systems, data, networks, and other critical information technology (IT) infrastructure. Cybersecurity threat management is used to detect, counter, and mitigate cybersecurity threats as they arise. Each of the many cybersecurity activities plays a crucial role in securing enterprise-wide IT infrastructure and in enabling consistent and reliable computing operations. Further, critical enterprise-specific or enterprise-type threat protections can be configured and deployed. These latter threat protections can include advanced authorization techniques such as biometric verification, two-factor authentication, coded challenges and responses, encrypted or secured communications channels such as virtual private networks, and so on. The enterprises include both private and public organizations that can range in size from large to medium, and to small in terms of numbers of employees, annual sales, numbers of divisions or locations, and the like. The enterprises can include businesses, hospitals, government agencies, research facilities, and universities, among many others. The enterprises are acutely aware that cybersecurity best practices are not merely optional, desirable, or “nice to have”, but rather, implementing cybersecurity best practices is essential to the continued operation of, and indeed the survival of, the enterprises.

Cybersecurity integrates highly complicated suites of tools and activities. The challenge is to execute the integration correctly. Specifically, proper cybersecurity implementation and configuration is extremely complex and expensive. Further, the tasks associated with cybersecurity are constantly in flux. Cybersecurity measures undertaken today by the enterprises can detect and prevent known or recently discovered attack techniques. However, the techniques and ploys used by cybercriminals, specifically to thwart or circumvent the cybersecurity measures, are constantly evolving. Nearly as soon as a tool is developed for identifying, reacting to, and eradicating a cybersecurity threat such as a virus, a Trojan horse program, a phishing scheme, or a denial-of-service attack, the cybercriminals adapt their cyberthreat techniques. This results in an ever-escalating, high risk, high stakes cyber-game of cat and mouse. Cyberthreats have evolved and adapted to target popular electronic devices, to use new or recently discovered attack vectors, to fine tune and improve social engineering stratagems, and to employ other foul deceptions. The cyberthreats further target newly discovered flaws and vulnerabilities in hardware and software. This latter class of cyberthreat is often referred to as a “zero-day” attack since the victims of the attack have had zero days to identify and counter the attack. Purported links to scandalous and compromising photographs of famous people, earnest promises of shared wealth from deposed or exiled continental nobility, and desperate pleas for help from criminals posing as relatives and friends who are in serious legal or financial trouble while visiting distant locations are specifically designed by their perpetrators to induce a visceral reaction and to motivate their victims to react quickly and unthinkingly. Other deceits include completely copying the landing page of a website with which the victim is familiar. Unless the victim looks at the web address, they would be unaware of the deception until their personal information is stolen, or their bank accounts are emptied. Further subterfuges include “man-in-the-middle” attacks, where the communications between an unwitting victim and a legitimate website are monitored to harvest personal information, usernames and passwords, and other confidential information.

In disclosed techniques, cybersecurity management is accomplished based on cybersecurity operations case triage groupings. A plurality of network-connected cybersecurity threat protection applications is accessed. The threat protection applications include endpoint protection, anti-phishing and antivirus tools, firewalls, denial-of-service sensing, ransomware detection, and so on. A plurality of inputs is received from the cybersecurity threat protection applications, wherein the plurality of inputs is initiated by one or more cybersecurity events. The inputs can include types of cybersecurity events, numbers of events, numbers of affected users and devices, etc. A computer platform is used to analyze metadata associated with the plurality of inputs from the cybersecurity threat protection applications. The metadata can include information such as status and other information associated with a detected cybersecurity threat. The metadata can include a time and a frequency of cybersecurity threat protection application inputs, techniques used to receive the application inputs, which tool provided the application inputs, who was operating a tool or device that initiated the input, etc. The inputs are triaged into groupings, based on the metadata. The groupings can include types and numbers of inputs, devices affected, locations from which the inputs are sent, and so on. A cybersecurity threat response is generated, based on the groupings. The threat response can include initiating workflows, removing viruses and trojans, notifying law enforcement, etc.

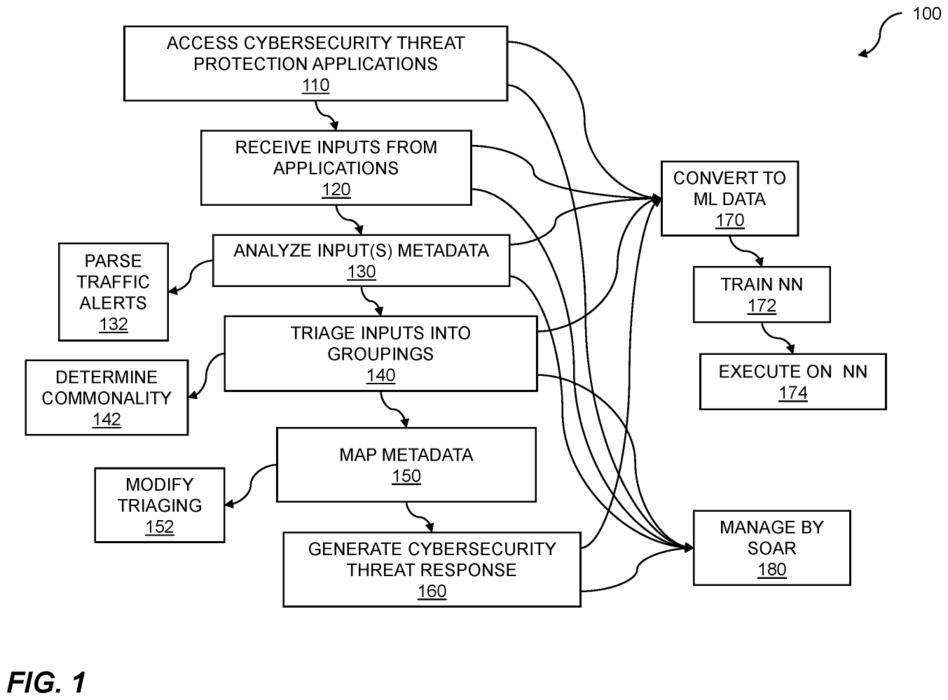

FIG. 1 is a flow diagram for cybersecurity operations case triage groupings. Cybersecurity management can be accomplished based on techniques associated with cybersecurity operations case triage groupings. The operations case triage groupings can be used to group similar types of cybersecurity attacks; to determine a number of similar attacks, a number of people, and devices affected by the cybersecurity attack; and so on. The case triage groupings can also be used to determine whether one or more cybersecurity attacks are true positives, can be attributable to another cause such as software license expiration warnings, and so on. A plurality of network-connected cybersecurity threat protection applications can be accessed. The cybersecurity threat protection applications can include endpoint protection tools, anti-phishing and antivirus apps, firewalls, man-in-the-middle detection apps, denial-of-service detectors, ransomware detection tools, and so on. A plurality of inputs can be received from the cybersecurity threat protection applications, wherein the plurality of inputs is initiated by one or more cybersecurity events. The cybersecurity events can include attacks on IT infrastructure, virus outbreaks, etc. The cybersecurity threat inputs can include possible threats, known threats, confirmed threats, etc. The cybersecurity threats can be accompanied by an increase in the number of notifications.

The inputs can include or represent an anomalous information technology (IT) infrastructure operation, detected threats and attacks, utilization of discovered vulnerabilities, and so on. A computer platform can be used to analyze metadata associated with the plurality of inputs from the cybersecurity threat protection applications. The metadata can include a variety of information types such as status information associated with a type of input related to a detected cybersecurity threat. Other metadata can include a time and a frequency of cybersecurity threat protection application inputs, one or more techniques used to receive the application inputs, who or which tool provided the application inputs, etc. The inputs can be triaged into groupings, based on the metadata. The groupings can be based on a type of input received from one or more network-connected cybersecurity threat protection applications, a time that an input is received, a quantity of inputs received, etc. The type of input can include a type of attack, one or more sources of an attack, the number of user applications sending alerts, and so on. A cybersecurity threat response is generated, based on the groupings. A generated response can include starting a workflow, a protocol, a response “punch list”, etc., to address the threat. The generated response can include initiating a device or access lockdown, commencing a threat eradication procedure, and so on. In embodiments, the response can be provided to a cybersecurity threat management entity such as the integrated cybersecurity threat management engine. Triaging inputs from network-connected cybersecurity threat protection applications is useful to identifying the severity and extent of cybersecurity threats.

The flow 100 includes accessing a plurality of network-connected cybersecurity threat protection applications 110. The threat protection applications can monitor, protect, and defend computer systems, data systems, data networks, handheld electronic devices, and so on against various types of malicious attacks. The malicious attacks can include malware attacks, hacking attacks, denial-of-service attacks (DoS), distributed denial-of-service attacks (DDoS), man-in-the-middle attacks, ransomware attacks, and so on. The applications can include antivirus and anti-phishing applications, tools for threat hunting and threat intelligence, identity verification, endpoint protection, and so on. The applications can further include firewalls and other blocking technology. The plurality of cybersecurity threat protection applications can include at least two different data management schemas. A management schema can be based on a security domain which can contain one or more database objects. Access to the one or more database objects can be controlled by granting access privileges to each user or role, where a role can include a user, a manager, an administrator, and so on. The access can be controlled by an access control list (ACL).

Threat protection applications are used to provide a variety of protections and defenses for computer systems, data systems, data networks, endpoint devices, and so. The threat protection applications are installed on the various IT components to counter the increasing variety of malicious cyberattacks. The plurality of cybersecurity threat protection applications can include security information and event management (STEM) applications. More advanced techniques can also be applied. In embodiments, the plurality of cybersecurity threat protection applications can include security orchestration, automation, and response (SOAR) applications (further described below). Discussed previously, the malicious cyberattacks can include malware attacks, hacking attacks, distributed denial-of-service attacks (DDoS), man-in-the-middle attacks, and so on. The applications can include antivirus, anti-phishing, and anti-cryptojacking applications; tools for threat hunting and threat intelligence; identity verification; endpoint protection; forensic investigation; incident management; and so on. The plurality of cybersecurity threat protection applications can include data management schemas. A management schema can be based on a security domain which can contain one or more database objects. Access to the one or more database objects can be controlled by granting access privileges to each user or role, where a role can include a user, a manager, an administrator, and so on.

The flow 100 includes receiving a plurality of inputs 120 from the cybersecurity threat protection applications, wherein the plurality of inputs is initiated by one or more cybersecurity events. The inputs can include alarms, alerts, notifications, status changes and updates, warnings, etc. The plurality of inputs can be received from one or more network-connected cybersecurity threat protection applications. The plurality of inputs can include threat notifications. The inputs can be in reference to virus detection, Trojan horse detection, insider threat detection, cryptojacking detection, intrusion detection, and so on. The inputs that are received can include one or more of signals, flags, SMS or email messages, indications, and other outputs generated by the plurality of applications. The inputs can be received as part of a cybersecurity management system. The inputs can include a simulated or synthetic notification, test notifications, status notifications, and so on. The simulated or test inputs can be used to determine the efficacy of detecting a threat and generating one or more inputs based on the threat. The simulated or test inputs can be used to test various threat scenarios. The testing can be based on simulation, emulation, hypothesis testing, and the like.

In embodiments, information about a device for which cybersecurity threat inputs were received can include a management level designation for the device or a user of the device. A management level designation for a device can include an unmanaged personal electronic device, an unsupported device, a managed corporate device, and so on. The management level designation for a user can include an employee, a temporary employee, a contractor, an affiliate, and the like. In other embodiments, the information about a device for which cybersecurity threat inputs were received can include a usage location designation. The usage location can include onsite or offsite; a building, floor, and room; a physical street address; a regional or national location; etc. In further embodiments, the information about a device for which cybersecurity threat inputs were received can include a security clearance designation for the device or a user of the device. A security clearance designation for a device or a user of the device can include a military or government clearance level, a corporate clearance level, access controlled by an access control list (ACL), and so on. In other embodiments, the information about a device for which cybersecurity threat inputs were received can include a security metric designation for the device or a user of the device. A security metric can include one or more of a mean-time-to-detect and mean-time-to-respond to a threat notification for the device or the user. A security metric can include known vulnerabilities of the device or known vulnerabilities based on what the user's access privileges. A security metric can include known security settings associated with the device.

The flow 100 includes analyzing, on a computer platform, metadata 130 associated with the plurality of inputs from the cybersecurity threat protection applications. The computing platform can include a handheld electronic device, a desktop or laptop computer, a server, a cloud server, a cloud-based analysis service, and so on. The metadata, or “data about data” can include critical information associated with one or more inputs. The metadata can include a type of cybersecurity threat, identifying information associated with an affected device, identity and location of an at-risk user, identifying information and location of vulnerable or affected IT infrastructure, and the like. The metadata can include information types such as status information, a type of device, a type of user, etc. The status information can be associated with a type of detected cybersecurity threat. Other metadata can include a time and a frequency of cybersecurity threat protection application inputs, techniques used to receive the application inputs such as observed or automatically delivered, who or which tool provided the application inputs, etc. In embodiments, the triaging can determine a commonality of threats among the plurality of inputs. The commonality of threats can include virus threats, intrusion events, etc. In embodiments, the analyzing is based on parsing 132 incoming traffic alerts from the cybersecurity threat protection applications. Since the various network-connected cybersecurity threat protection applications can be provided by a plurality of vendors, and since the inputs provided by the applications can include differing messages, formats, etc., the traffic alerts can be parsed and compared. That is, the inputs can be received from more than one cybersecurity threat protection applications, and the formats of the inputs can be different. An “alert” from one application may be labeled as an “alarm” by another, while both applications can detect the same virus attack. In embodiments, the cybersecurity threat can include a zero-day attack. A zero-day attack can be based on a newly discovered or previously undisclosed flaw in hardware, software, operating systems, network switches or routers, etc. The “zero-day” can refer to an amount of time (i.e., zero days) between the time of the exploit being used and the time that experts develop a technique for countering the attack.

The flow 100 includes triaging the inputs 140 into groupings, based on the metadata. The triaging can include sifting or filtering of the plurality of inputs from the threat protection applications to detect potentially suspicious activity associated with one or more elements of an IT infrastructure. In embodiments, the groupings can be based on a number of users experiencing the plurality of inputs. The number of users can include one or more users such as a single user; a small number, a medium number, or a large number of users; and so on. The users may be using devices that can be substantially similar. The users may be using operating systems or software configurations that are substantially similar, and so on.

In embodiments, the number of users can be matched against a threshold for the plurality of inputs. The threshold can include a baseline or nominal value, a tolerance, a percentage, a maximum value, and so on. The threshold can be used to determine a type of response that can be recommended, generated, undertaken, etc. Many usage examples exist. In one usage example, an input, indicating that a device associated with a single user has been determined to be infected with a virus or other threat, can be received. The single device can be blocked from access to a network such as an enterprise or institutional network until the virus is removed and remedial action has been completed. A different set of steps or actions can be taken as the numbers of users that are impacted increases. In a second usage example, inputs, indicating that virus infections have been detected on hundreds of devices, are received. The latter scenario can require more aggressive steps such as shutting down a network, deploying IT staff to remove and repair devices, and so on. Such immediate actions can be undertaken to prevent further spread of the virus and associated damage and disruption. In embodiments, the number of users that are affected can be used to determine a priority or urgency with which a cybersecurity threat can be handled.

In embodiments, the threshold can be based on a particular grouping. The particular grouping can be based on a type of device such as personal or organizational; a “class” or category of user such as administrative staff, organizational officers (e.g., “C-suite” employees); information technology staff; users with access to restricted, confidential, or classified data; etc. The particular grouping can be associated with a location such as a workgroup, a section, a department, or a division; an office, a building, or a campus; and the like. In embodiments, the threshold can be set recursively for a particular grouping. The recursive setting can include applying the threshold to the group as a whole, to each member of a group, etc. The recursive setting can include updating the threshold based on an increasing number of inputs associated with members of the group, and so on. In the flow 100, the groupings establish modal commonality 142 for the one or more cybersecurity events. The modal commonality can include a virus outbreak, a denial-of-service attack, a distributed denial-of-service attack, an endpoint attack, ransomware, crypto-jacking, etc. In embodiments, the triaging can determine commonality of threats among the plurality of inputs. Since the inputs can be received from more than one cybersecurity threat protection application, the formats of the inputs can be different. An “alert” from one application may be labeled as an “alarm” by another, while both applications can detect the same virus attack. In embodiments, the cybersecurity threat can include a zero-day attack. The triaging can be used to determine the validity of the inputs provided by the network-connected cybersecurity threat protection applications. In embodiments, the triaging can confirm a true positive analysis of one or more of the plurality of inputs. The triaging can determine whether the inputs refer to a cybersecurity threat event, an application status report, an expired application license, etc. In other embodiments, the triaging can confirm a true positive cybersecurity threat event.

Embodiments further include mapping the plurality of inputs from the cybersecurity threat protection applications. Discussed previously and throughout, network-connected cybersecurity threat protection applications that perform similar tasks such as virus detection tasks can provide inputs in a variety of formats. While one application can issue an “alert” upon detection of a virus, another application can issue a “warning”. Yet, the same virus can be detected by the different virus detection applications. The mapping can be used to determine that the different inputs and input formats can indeed refer to the same threat. In embodiments, the mapping can enable categorization of the groupings. The categorization can include categories for IT infrastructure such as hardware, software, data, networking, and the like. The categorizations can include a type of threat such as a virus outbreak or a DDoS attack. The categorization can include a priority level such as low, medium, high, or critical. In embodiments, the categorization of the groupings can modify the triaging. The modifying the triaging can include tuning or training the triaging to determine more quickly a true positive, to better rank a priority of a cybersecurity threat event, etc. Discussed below, the triaging that was modified can trigger a modified cybersecurity threat response.

The flow 100 further includes mapping the metadata 150 associated with the plurality of inputs from the cybersecurity threat protection applications. The mapping the metadata can be used to identify vulnerabilities associated with types of devices such as a type of personal electronic device, a model of network switch, a version of an application or operating system, and the like. In the flow 100, the mapping the metadata modifies 152 the triaging. The modified triaging that derives from the mapping the metadata can include detecting versions or evolutions of threats such as virus threats, clusters of vulnerable devices, etc.

The flow 100 includes generating 160 a cybersecurity threat response. The generating a cybersecurity threat response comprises generating a cybersecurity threat response based on the groupings that resulted from triaging the inputs. A generated response can include initiating a threat response process or protocol, starting a workflow or “punch list” to address the threat, and so on. The generated response can further include initiating a lockdown of a device or access to the device, commencing a threat eradication procedure, and so on. The response that is generated targets one or more types of events. In embodiments, the cybersecurity threat response can address a zero-day event. In other embodiments, the response can be provided to a cybersecurity threat management entity such as cybersecurity threat management component or entity. The cybersecurity threat management entity can include a human-based entity, a machine-based entity, a trained neural network, and so on. In embodiments, the cybersecurity threat management entity can include one or more cybersecurity professionals. The one or more professionals can activate a workflow, initiate a cybersecurity process or policy, and the like.

The generating a cybersecurity threat response can include generating a notification, where the notification can be used to trigger a variety of responses. The generated response to a cybersecurity threat can include managing one or more devices; individual users, user groups, or types of users; portions or regions of a data network; and so on. The generating a response can include granting user access to an asset to fix a problem, denying access to lock out access to the asset, isolating one or more devices, notifying security or law enforcement, and the like. The generated response can include one or more procedures, protocols, tasks, techniques, workflows, etc., associated with cybersecurity. In embodiments, the generating a response to a cybersecurity threat can include managing one or more of antivirus analysis, phishing attack response, review, security information and event management (STEM) triage, threat hunting, insider threat protection, threat intelligence, identity verification reinforcement, endpoint protection, forensic investigation, cryptojacking, vulnerability, cloud security orchestration, and end-to-end incident lifecycle cases.

In the flow 100, the accessing, the receiving, the analyzing, the triaging, and the generating are converted 170 to machine learning training data. The training data can include the inputs received from the network-connected cybersecurity threat protection applications. The training data can further include historical data associated with past inputs received, synthetic data generated for machine learning training purposes, and so on. The training data is accompanied by expected outcomes inferred based on processing or analyzing the training data. The expected outcomes can include determining a true positive analysis of inputs, confirming a true positive threat event, and the like. The expected outcomes can include workflows to locate, remove, remediate, etc., the cybersecurity threat. The expected outcomes can include actions such as one or more of removing the virus from the email messages, blocking the sender of the messages, updating antivirus software, pushing antivirus software updates out to client computers and portable devices, etc. The flow 100 includes training 172 a neural network using the machine learning training data. The training of the neural network can include providing training data to the neural network, observing inferences formed by the neural network, adjusting weights associated with nodes within the neural network, and so on. The observing and adjusting can continue until the neural network is able to form the expected inferences (outcomes) for the training data provided. The flow 100 further includes executing 174 the analyzing, the triaging, and the generating on the neural network that was trained. The neural network can continue to “learn” based on the processing of data other than training data. The learning can be accomplished by the network to improve convergence speed, inference accuracy, etc. In the flow 100, the accessing, the receiving, the analyzing, the triaging, and the generating are managed 180 by a security orchestration, automation, and response (SOAR) system. Discussed previously and throughout, the SOAR system can comprise a cybersecurity threat management entity, where the cybersecurity threat management entity can be based on software, hardware such as specialized hardware, a suite of software tools or applications, and the like. The SOAR system can include an in-house system, a commercially available system, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

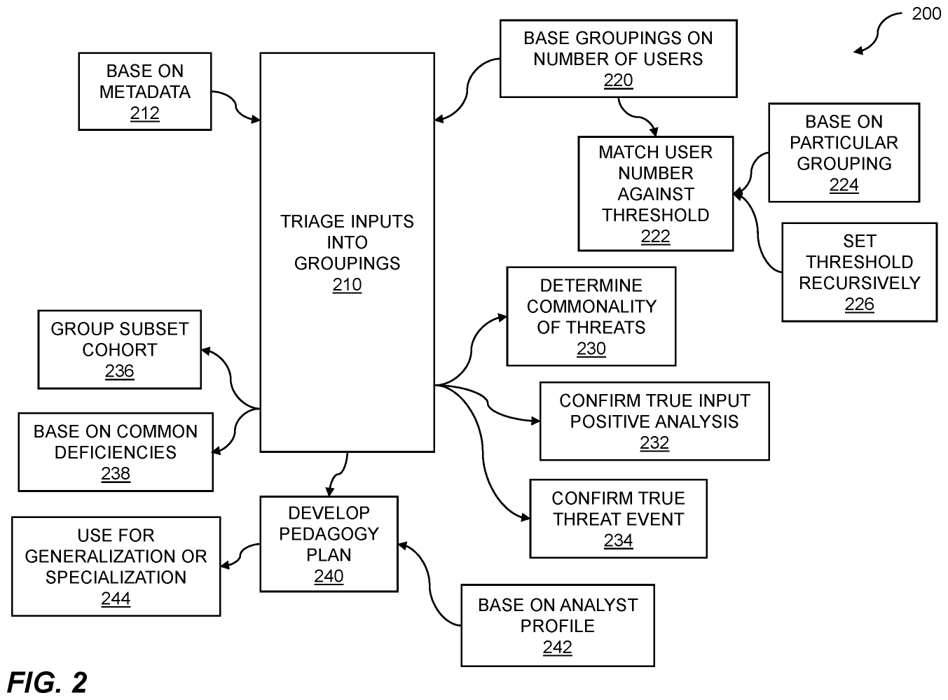

FIG. 2 is a flow diagram for triaging groupings. New cybersecurity threats can be detected by one or more applications, such as network-connected cybersecurity threat protection applications. The detection of the cybersecurity threats can generate one or more inputs that can be received by a component such as a cybersecurity management component. The inputs can be received in the form of flags, warnings, notices, alerts, and so on that can be received via email, text message (SMS), graphical alerts on a screen associated with a computing device, etc. A computer platform is used to analyze metadata associated with the plurality of inputs from the cybersecurity threat protection applications. The analysis can be used to determine a type of threat, a number of inputs received, and so on. The metadata can include a type of threat, an affected device, an at-risk user, vulnerable IT infrastructure, and the like. The inputs can be triaged into groupings, based on the metadata. The groupings can include a type of threat such as a virus detection threat, where inputs associated with the virus detection threat can be received from one or more network-connected cybersecurity threat protection applications. The groupings can include a number of users, a type of user such as users associated with a department within an organization, locations of users, types of devices, etc. A cybersecurity threat response can be generated, based the groupings. The cybersecurity threat response can include initiating a response workflow, following a response procedure or protocol, and the like.

The flow 200 includes triaging inputs 210 received from the cybersecurity threat protection applications into groupings. The inputs that can be received can be based on detection of various types of cybersecurity threats. The cybersecurity threats that can cause inputs to be generated can include endpoint attacks, phishing attempts, virus detection, firewall violations or attacks, man-in-the-middle attacks, denial-of-service or distributed denial-of-service attacks, ransomware events, and so on. In the flow 200, the triaging is based on metadata 212. The metadata can be associated with the plurality of inputs from the cybersecurity threat protection applications. The metadata can include information types such as status information. The status information can be associated with a type of a detected cybersecurity threat. Other metadata can include a time and a frequency of cybersecurity threat protection application inputs, techniques used to receive the application inputs, who or which tool provided the application inputs, etc. In embodiments, the triaging can determine commonality of threats among the plurality of inputs. Since the inputs can be received from more than one cybersecurity threat protection application, the formats of the inputs can be different. An “alert” from one application may be labeled as an “alarm” by another, while both applications can detect the same virus attack. In embodiments, the cybersecurity threat can include a zero-day attack.

In the flow 200, the groupings are based on a number of users 220 experiencing the plurality of inputs. The number of users can include a single user, a small number of users, a large number of users, and so on. The users may be using substantially similar devices, substantially similar operating systems or software configurations, and so on. In the flow 200, the number of users is matched 222 against a threshold for the plurality of inputs. The threshold can be used to determine a type of response that can be taken. In a usage example, an input that a single user is using a device on which a virus is detected can be received. The single device can be blocked on the network until the virus is removed and remedial action can be taken. In another usage example, inputs indicating that hundreds of devices are infected with a virus are received. The latter scenario can require immediate action in order to prevent further spread of the virus. In embodiments, the number of users can be used to determine a priority or urgency with which a cybersecurity threat can be handled. In the flow 200, the threshold can be based 224 on a particular grouping. The particular grouping can include a type of device; a class of user such as administrative, financial, IT, C-suite; etc. The particular grouping can be associated with a location such as a workgroup, a section, a department, a division, and the like. In the flow 200, the threshold can be set recursively for a particular grouping. The recursive setting can include applying the same threshold to each member of a group, updating the threshold based on an increasing number of members of the group, and so on.

In the flow 200, the groupings can establish modal commonality 230 for the one or more cybersecurity events. Modal commonality can include a type of cybersecurity threat such as a phishing expedition, a virus outbreak, etc. Modal commonality can include a cybersecurity attack vector such as a port exploit, an operating system or software vulnerability, and the like. In the flow 200, the triaging (discussed previously) can confirm a true positive analysis 232 of one or more of the plurality of inputs. The true positive analysis can include matching inputs to a type of input such as an input from an antivirus application. The true positive analysis can be used to map responses from two or more cybersecurity threat protection applications. In a usage example, antivirus applications can produce an input indicating the presence of a virus. A first application can issue a “warning”, a second application can issue an “alarm”, a third application can issue an “alert”, and so on. While the inputs from the plurality of applications, such as using differing texts, can be different, the differing texts can all refer to the same virus threat. In the flow 200, the triaging can confirm a true positive cybersecurity threat event 234. Applications can generate inputs for a variety of reasons such as detection of a cybersecurity threat. The applications can also generate other inputs such as inputs associated with notice of an update to an application, a license expiration date, an application status, etc. A true positive can be associated with an input associated with a cybersecurity threat. A “false positive” can be associated with a status input, an informational input, and so on.

The flow 200 includes grouping a subset cohort 236 of analysts staffing the cybersecurity security operation center (SOC) for additional caseload history analysis. The subset cohort can include new or inexperienced analysts; analysts who are due for recertification; analysts who have experienced particular difficulties addressing a cybersecurity threat, and so on. In the flow 200, the additional caseload history is based on common resolution deficiencies 238. The deficiencies can include overly long cybersecurity threat management times, inability to counter or remove the threat, insufficient communication with peers and supervisors, and the like. The deficiencies can include gaps in training, certification, experience, etc. The deficiencies can be identified using a variety of techniques. The common resolution deficiencies can be based on an aggregation of the threat response resolution metrics. The resolution metrics can include an initial response time, a closure response time, a peer interaction metric, and so on. The aggregation of the metrics can indicate a cohort-wide training gap, consistently slow response times, etc.

The flow 200 further includes developing a pedagogy plan 240 for one or more analysts within a cohort of analysts staffing the SOC. The pedagogy plan can include a “lesson plan” for training the analysts. The pedagogy plan can include coursework, laboratory work, mentoring sessions, internships, and so on. The plan can include remedial analyst training when and if needed by the cohort of analysts. The plan can further include analyst certification training. In the flow 200, the pedagogy plan is developed based on the analyst threat response profile 242, which can be augmented with threat response resolution metrics. The pedagogy plan can address cybersecurity threat initial response time, closure response time, peer and supervisor interaction, etc. The pedagogy plan can be developed using a variety of techniques such as advice from experts, use of a proven plan, and the like. Such techniques can be static and may not be adaptable to the needs of individual analysts; however, the pedagogy plan can be developed using a machine learning (ML) algorithm (discussed later). The machine learning algorithm can be developed by training a network such as a neural network. The training can be based on the application of a training dataset, where the training dataset includes data and expected results from processing the data. The ML algorithm can identify “areas for improvement” associated with one or more analysts. In the flow 200, the pedagogy plan is developed for analyst generalization and/or specialization 244. Analyst generalization can include analyst training for the cohort of analysts for a plurality of various cybersecurity threats. Analyst specialization can include analyst training for mastering management and response to a specific type or types of cybersecurity threats.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

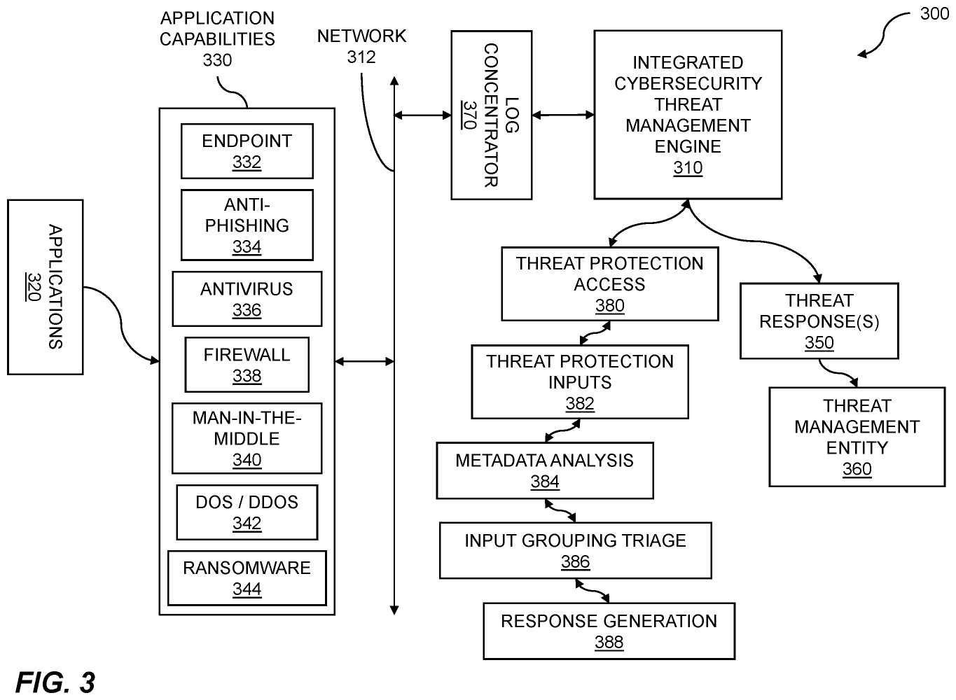

FIG. 3 is a system block diagram for cybersecurity operations case triage groupings. Cybersecurity operations center load balancing can be implemented based on workflow management, where the workflow management uses a supervisory workflow element. The supervisory workflow element enables cybersecurity management of cybersecurity operations. The cybersecurity management includes cybersecurity operations case triage groupings. Threat management such as cybersecurity threat management includes detecting new cybersecurity threats and assigning those threats to one or more analysts for action. In an example threat management scenario, an analyst to whom a new cybersecurity threat can be assigned can be selected for the assignment based on an analyst threat response profile. The threat response profile is produced by analyzing triage results from a security operations center caseload history. The profile can include analyst qualifications, certifications, training, experience, success rate, and so on. The profile can be augmented with threat response resolution metrics such as an initial response time, a closure response time, and a peer interaction metric. The selected analyst may not be available to handle the new cybersecurity threat because of a caseload that is already “heavy” or full. In order to make the analyst available to handle the new cybersecurity threat, one or more cases within the analyst's caseload can be reassigned to one or more other analysts, thereby freeing the analyst to handle the new cybersecurity threat. Cybersecurity management is accomplished by cybersecurity operations case triage groupings. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. A cybersecurity threat response is generated, based on the groupings.

An example system block diagram for threat management is shown. Threat management such as cybersecurity threat management is critical to an organization. The cybersecurity threat management is used to monitor operations such as data operations within the organization. When anomalies or outright threats are detected, threat management applies a variety of techniques to determine the cause of an anomaly, a source of a threat, and responses to the anomalies and threats. The system block diagram 300 can include an integrated cybersecurity threat management engine 310. The management engine can access applications; collect and ingest log files from the applications; sort, integrate, and evaluate threat protection elements; and so on. The engine can include one or more processors, processor cores within integrated circuits or chips, CPUs, GPUs, and so on. The management engine can be coupled to a network 312 such as a computer network. The network can be based on wired and wireless communications techniques.

The system block diagram 300 can include a plurality of applications 320. The applications can include network-connected cybersecurity threat protection applications. The applications can perform tasks such as network and processor monitoring; data integrity monitoring; data, services, and physical access control; etc. Some applications within the plurality of threat protection applications can perform unique tasks, can perform similar or redundant tasks, and the like. The applications within the plurality of cybersecurity threat protection applications can include application capabilities 330. The application capabilities can include endpoint protection 332. Endpoint protection can include authentication and supervision of “endpoint” devices. The endpoint devices can include desktop computers, laptop computers, tablet computers, personal electronic devices such as smartphones and PDAs, and so on. Endpoint protection can include enabling access of the endpoint devices based on one or more rights. Access rights can include creating, editing, and deleting files, folders, and so on. Access rights can include read-write, read-only, write-only (e.g., a drop box), etc. Endpoint protection can restrict access, impose security rules, and the like.

Application capabilities can include anti-phishing 334 techniques. “Phishing” threats can be based on sending fraudulent email messages, where the messages appear to be from a legitimate sender who may be known to the recipient. The messages are used to gather sensitive, identifying information about an individual which is then used to defraud the individual. The application capabilities can include antivirus 336 techniques. Antivirus techniques can be used to detect viruses that can be embedded in data such as images, audio files, and so on. The application capabilities can include firewall 338 techniques. Firewall techniques can be used to block network traffic, applications, etc. that can attempt to penetrate a network and IT infrastructure using one or more network ports and communications protocols. The application capabilities can include man-in-the-middle detection and prevention techniques 340. A “man-in-the-middle” cybersecurity threat includes interception of communications between a user or endpoint device and an entity with which the user or endpoint device is trying to communicate. The communications interception attempts to extract personal or identifying information from the communications for fraudulent purposes. The application capabilities can include denial-of-service (DOS) and distributed denial-of-service (DDOS) 342 detection techniques. Denial-of-service attacks attempt to render a website, computer, processor, and so on unreachable or unusable by overwhelming it with requests. The application capabilities can include ransomware 344 detection techniques. Ransomware attacks encrypt a victim's data. The encrypted data is only decrypted, if at all, after payment of a ransom.

The system block diagram 300 includes one or more threat responses 350. The one or more threat responses are generated by the integrated cybersecurity threat management engine 310. The generated responses can be provided to a cybersecurity threat management entity 360. A cybersecurity threat management entity can include a human-based entity, a machine-based entity, or a combination of human-based and machine-based entities. In embodiments, the cybersecurity threat management entity can be a cybersecurity professional. The cybersecurity professional can be an employee of an organization, a consultant to the organization, and so on. In other embodiments, the cybersecurity threat management entity can be a security orchestration, automation, and response (SOAR) application. The SOAR application can handle threat detection, response generation, case tracking, and so on. The system block diagram can include a log concentrator 370. The log concentrator can sort a plurality of log files, can integrate the log files, and so on. The concentrator can extract key information from the log files. The concentrator can compress log file data.

The system block diagram 300 includes cybersecurity threat protection application access 380. A plurality of cybersecurity threat protection applications can be accessed. The cybersecurity threat protection applications can be network connected. The applications can include antivirus, anti-phishing, distributed denial-of-service (DDoS), intrusion detection, and other applications. The access to the applications can be enabled by the integrated cybersecurity threat management engine. The applications can reside with IT infrastructure operated by an organization, can be provided as a cloud service, etc. The system block diagram 300 includes threat protection inputs 382. The inputs can be received from the cybersecurity threat protection applications. The inputs can be initiated by one or more cybersecurity events. In embodiments, the inputs can be received by a security orchestration, automation, and response (SOAR) system or microservice. Discussed previously, the SOAR application microservice can handle threat detection, response generation, case tracking, and so on. The system 300 includes metadata analysis 384. The metadata can be associated with the plurality of inputs from the cybersecurity threat protection applications. The metadata analysis can be accomplished using a computer platform. The metadata can include a variety of information types such as status information associated with a type of a detected cybersecurity threat. Other metadata can include a time and a frequency of cybersecurity threat protection application inputs, one or more techniques used to receive the application inputs, who or which tool provided the application inputs, etc.

The system block diagram 300 can include input grouping triage 386. The groupings can be based on type of input received from one or more network-connected cybersecurity threat protection applications, a time that an input is received, a quantity of inputs received, etc. The type of input can include a type of attack, one or more sources of an attack, the number of user applications sending alerts, and so on. The triaging can be used to detect a “zero-day” event or attack. A zero-day attack can include an attack based on a vulnerability for which a fix has yet to be developed. That is, “zero days” have elapsed since the discovery of the vulnerability. The triaging can further be used to determine whether the inputs received from the cybersecurity threat protection applications are indicating a true positive or a false positive. In a usage example, inputs are received from virus detection applications loaded on a substantial number of end-user computers. Upon analysis of the inputs, the triaging determined that inputs indicating that the licenses for the virus detection application were about to expire and generated the inputs. Thus, the inputs are a “false positive” for a virus attack.

The system block diagram 300 can include response generation 388. The response generation can include generating a cybersecurity threat response that can be based on the groupings that resulted from triaging the inputs. A generated response can include starting a workflow or “punch list” to address the threat. The generated response can further include initiating a device or access lockdown, commencing a threat eradication procedure, and so on. In embodiments, the response can be provided to a cybersecurity threat management entity such as the integrated cybersecurity threat management engine. The cybersecurity threat management entity can include a human-based entity, a machine-based entity, a trained neural network, and so on. In embodiments, the cybersecurity threat management entity can include one or more cybersecurity professionals. The one or more professionals can activate a workflow, initiate a cybersecurity process or policy, and the like. In other embodiments, the cybersecurity threat management entity can be a security orchestration automation and response (SOAR) application. The application can include an in-house application, a commercially available application, etc.

The generating a cybersecurity threat response can include generating a notification, where the notification can be used to trigger a variety of responses. The generated response to a cybersecurity threat can include managing one or more devices; individual users, user groups, or types of users; portions or regions of a data network; and so on. The generating a response can include granting user access to an asset to fix a problem, denying access to lock out access to the asset, isolating one or more devices, notifying security or law enforcement, and the like. The generated response can include one or more procedures, protocols, tasks, techniques, workflows, etc., associated with cybersecurity. In embodiments, the generating a response to a cybersecurity threat can include managing one or more of antivirus analysis, phishing attack response, review, security information and event management (STEM) triage, threat hunting, insider threat protection, threat intelligence, identity verification reinforcement, endpoint protection, forensic investigation, cryptojacking, vulnerability, cloud security orchestration, and end-to-end incident lifecycle cases.

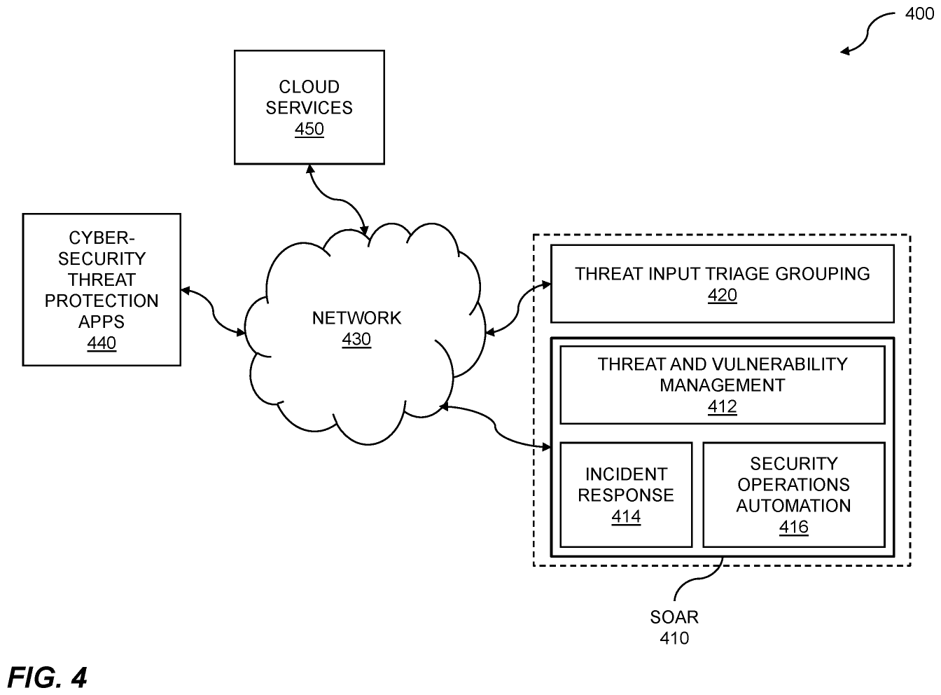

FIG. 4 illustrates a cloud-connected security orchestration, automation, and response (SOAR) system. Discussed above and throughout, cybersecurity threats occur as often as every few seconds. These threats target individual users, businesses, universities, hospitals, government agencies, and so on. The cybersecurity threats constitute extreme menaces, and indeed existential crises, to the enterprises. Cybersecurity threat management includes identifying that a threat is underway, what IT infrastructure and data are under attack, the type of threat, etc. The cybersecurity threat management ideally then proceeds to block and remove the threat, isolate affected infrastructure, perform eradication or remediation, and the like. Cybersecurity management is enabled by cybersecurity operations case triage groupings. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. The inputs are triaged into groupings, based on the metadata. A cybersecurity threat response is generated, based on the groupings.

A cloud-connected security orchestration, automation, and response (SOAR) system is illustrated 400. The SOAR can comprise a cybersecurity component such as 410, where the SOAR can be based on one or more cybersecurity threat protection applications, tools, techniques, and so on. The SOAR can enable data collection from a wide range of data sources such as threat data sources. The threat data sources can include data uploaded by cybersecurity experts, data produced by cybersecurity threat protection applications, and so on. The SOAR can be used to manage threat protection processes, anti-threat technologies, and human expertise. The SOAR can centralize management of IT assets such as networks, processors, data storage elements, etc. The SOAR can provide threat alerts and can also provide contexts for the alerts. The SOAR can further automate responses to threats, adapt the responses using machine learning, and so on.

The SOAR 410 can include one or more components associated with cybersecurity threat management. The SOAR can include a threat and vulnerability management component 412. The threat and vulnerability management component can configure and control IT infrastructure elements such as routers, switches, processors, storage area networks (SANs), and so on. The SOAR can include an incident response component 414. The incident response component can provide alerts, can trigger one or more actionable responses, and the like. In embodiments, the actionable response can enable scalability of a connected SOAR system. The SOAR can be scaled up to address a large number of threats, to reduce threat response time, etc. In embodiments, the actionable response can include a recommendation for a cybersecurity professional. The recommendation can include a recommendation for a threat response policy, a source for further information about the threat, etc. In further embodiments, the actionable response can include an autonomic network reconfiguration. An autonomic network reconfiguration can include isolating IT elements, restricting IT elements, and the like. In embodiments, the actionable response can include an autonomic cybersecurity threat protection application reconfiguration. The threat protection application reconfiguration can include isolating, reinstalling, reconfiguring, or rebooting an application. The threat protection application reconfiguration can include synchronizing operation of two or more threat protection applications.

The SOAR can include security operations automation 416. Security operations management can include automatically securing IT infrastructure elements such as switches, routers, processors, storage elements, etc., where the securing can be based on a procedure, a policy, and so on. The security operations automation can include updating IT element software and firmware, installing and configuring security software such as antivirus software, and the like. The SOAR can be associated with a threat input triage grouping element 420. The threat input triage grouping element can triage a plurality of inputs received from the cybersecurity threat protection applications into groupings. The inputs can include alerts, text or SMS messages, email, a rendering on a graphical display, and so on. The triaging can be based on metadata associated with the plurality of inputs from the cybersecurity threat protection applications. Discussed above and throughout, the metadata can include a variety of status and other information such as a time and a frequency of cybersecurity threat protection application inputs, one or more techniques used to receive the application inputs, who or which tool provided the application inputs, etc. The inputs that are received are triaged into groupings, based on the metadata. The groupings can establish modal commonality for the one or more cybersecurity events. A modal commonality can include a virus attack, a DDoS attack, hijacking events, etc. Recall that a cybersecurity threat response can be generated, based on the groupings. The response can include a workflow that can be developed to address, rectify, remediate, prevent, etc. the cybersecurity threat. The cybersecurity threat response can address various types of events such as a zero-day event.

The supervisory workflow element can provide access to a threat protection workflow, processing of notifications received from one or more cybersecurity threat protection applications, detection of actions within a workflow such as an irreversible action, and so on. In embodiments, the supervisory workflow element can be structured to perform a test on a cybersecurity threat protection application notification. The test can be used to verify a cause for the notification, to compare the notification with one or more other notifications from the same threat protection application or from other threat protection applications, etc. In embodiments, the test can include an if/then analysis, a table lookup analysis, an if/then/else analysis, or a machine learning algorithm-based analysis. In a usage example, two antivirus applications can be synchronized. One antivirus application can provide an alert for a detected cybersecurity threat, while the second application can provide no indication of a threat. Because of differing detection results, the applications can be analyzed for proper operation, checked for malware, and so on. The supervisory workflow element can perform these checks and any required remediations without burdening the SOAR.

The SOAR can use a network 430 to access a plurality of cybersecurity threat protection applications 440. The network can include a wired network, a wireless network, a hybrid wireless/wireless network, and so on. The network can be based on wired networking standards such as Ethernet™ (IEEE 802.3), wireless networking standards such as Wi-Fi™ (IEEE 802.11), and so on. The cybersecurity threat protection applications can provide capabilities such as endpoint protection, anti-phishing, antivirus, firewalls, and so on. The cybersecurity threat protection applications can further detect and protect against man-in-the middle ruses, denial-of-service (DOS) and distributed denial-of-service (DDOS) attacks, ransomware, and the like. In embodiments, the background synchronization service can communicate to the plurality of network-connected cybersecurity threat protection applications using cloud services 450. The cloud services can provide access and can provide IT services such as software as a service (SaaS), platform as a service (PaaS), infrastructure as a service (IaaS), and so on.

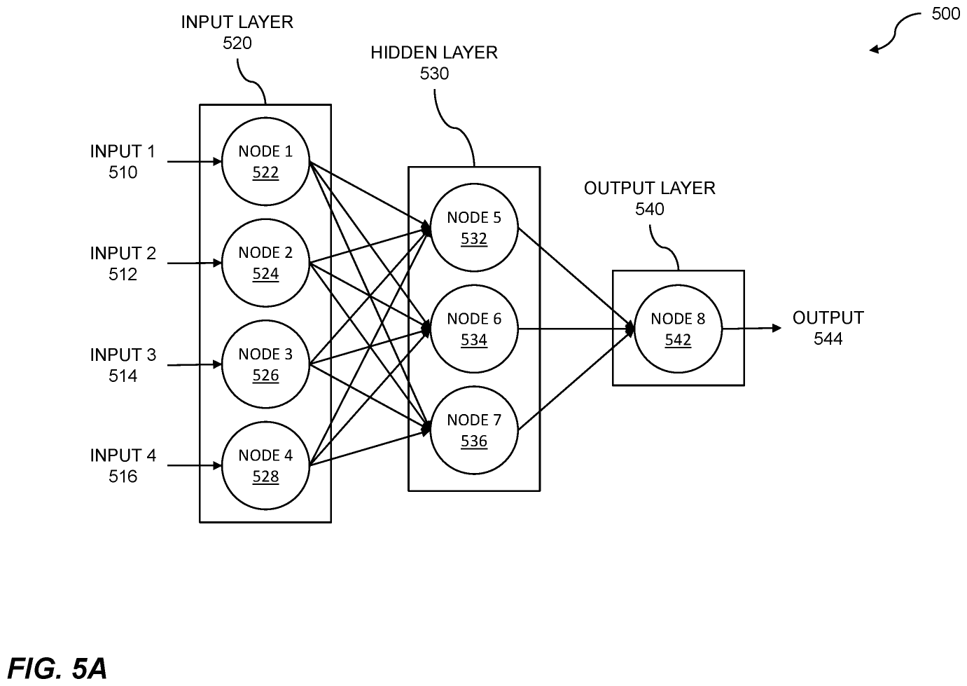

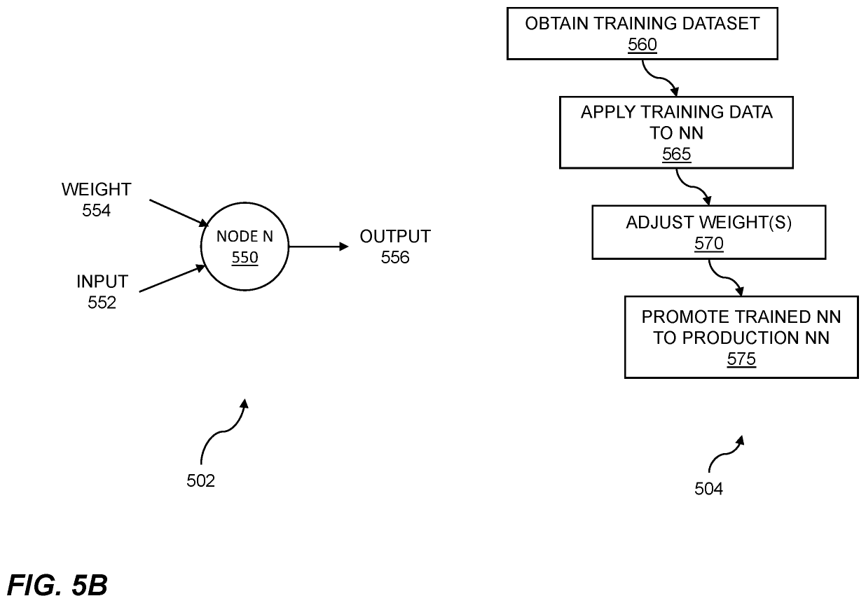

FIG. 5A shows an example neural network for machine learning. The neural network for machine learning can be based on a variety of neural network types such as a convolutional neural network (CNN), a deep neural network (DNN), a recurrent neural network (RNN), and so on. The neural network for machine learning comprises a plurality of layers, where the layers can include one or more of an input layer, an output layer, a convolutional layer, a bottleneck layer, an activation layer, and the like. The bottleneck layer, if present within the neural network, can be used for neural network training. The trained neural network can be applied to cybersecurity operations tasks such as cybersecurity operations case triage groupings. A neural network for machine learning can apply classifiers. The classifiers can be learned based on one or more inputs from a plurality of network-connected cybersecurity threat protection applications. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. The inputs are triaged into groupings, based on the metadata. A cybersecurity threat response is generated, based on the groupings.

The example 500 shows a neural network for machine learning. The neural network includes one or more layers such as input layers, hidden layers, and output layers. Layers, such as convolutional layers, activation layers, bottleneck layers, etc., that perform operations associated with applications such as machine learning can also be included within the example neural network. Data can be provided to the neural network though inputs such as input 1 510, input 2 512, input 3 514, and input 4 516. While four inputs are shown, other numbers of inputs can also be applied to the neural network. The data can include training data, production data, etc. The data is provided to an input layer 520 of the neural network. The input layer comprises one or more nodes such as node 1 522, node 2 524, node 3 526, and node 4 528. While four nodes are shown within the input layer, other numbers of nodes can be included. One or more weights (explained below) can also be provided to each node within the input layer. The outputs of the nodes associated with the input layer can be coupled to inputs of nodes associated with a hidden layer such as hidden layer 530. The hidden layer can comprise one or more nodes such as node 5 532, node 6 534, and node 7 536. While three nodes are shown, other numbers of nodes can be included in the hidden layer. In the example neural network, each output of the nodes associated with the input layer is coupled to each input of the nodes associated with the hidden layer. The coupling of each node output to each node input accomplishes a fully connected (FC) layer within the neural network.

The example neural network can include one or more hidden layers. The hidden layers can include substantially similar or substantially dissimilar numbers of nodes. The hidden layers can be fully connected layers as just described, convolutional layers where a subset of outputs is connected to a subset of inputs, bottleneck layers, activation layers, etc. The example neural network includes an output layer 540. The output layer can include one or more nodes such as node 8 542. While one node is shown within the output layer, the output layer can include more than one node. The output layer produces an output 544. The output can include a value, a probability, and so on.

FIG. 5B illustrates training a neural network for machine learning. Discussed previously, a neural network comprises layers of nodes or neurons such as artificial neuron 502. The artificial neuron can be configured to process input data in order to produce output data. An example node 550 is shown. A neuron can be coupled to one or more signals or inputs such as input 552, and one or more weights such as weight 554. The node multiplies each input by its corresponding weight and maintains a running sum of the resulting products. The output of the node, such as output 556, can be calculated by applying a function such as a transfer function to the sum of products of the inputs and weights. The transfer function can include various types of functions such as a unit step or threshold function, a sigmoid, a Gaussian function, a piece-wise linear function, and so on.

Each neuron within a neural network can be trained. The training can be based on using a dataset that includes known data. The training can be further based on comparing results of data processing by the neural network with expected results associated with the known data. The expected results include results of neural network processing of the dataset of known data. One or more weights associated with each node are adjusted until the neural network can form an inference that produces the expected result. In a usage example, a dataset of images of dogs or cats can be used to train a neural network to identify dogs or cats within images not included in the training data set. A flow for neural network training is shown. The neural network training can include training a neural network for machine learning applications. The flow 504 includes obtaining 560 a training dataset. The training dataset can include cybersecurity operations center caseload histories, resolutions to cybersecurity threats, and so on. The training dataset can include threat response resolution metrics. The training dataset can further include one or more objective ratings, where the objective ratings can be used to update the threat response resolution metrics. Further, a subjective rating can include a management-supplied rating, a peer-supplied rating, a machine-learning-supplied rating, etc.

The flow 504 includes applying 565 the training data to a neural network. The training data is provided to the inputs of the neural network and the neural network proceeds to process the test data. The flow 504 includes adjusting one or more weights 570 associated with the nodes of the neural network. The adjusting the weights can enable enhanced convergence by the neural network to an expected result. The enhanced convergence can reduce neural network processing time, improve inference accuracy, etc. The adjusting the weights can include an iterative process. The adjusting weights associated with the nodes within the neural network can become more accurate as further training data is provided. The flow 504 includes promoting the trained neural network 575 to a production neural network. The production neural network can be used to process data such as an SOC caseload history. The production neural network can continue to adapt or learn based on processing further data. The learning can include further adjustment to one or more weights associated with nodes within the neural network. In embodiments, the accessing, the analyzing, the augmenting, the receiving, and the assigning, all of which are discussed previously, can be converted to machine learning training data. The machine learning training data that was converted can be used to further train or adjust the machine learning neural network.

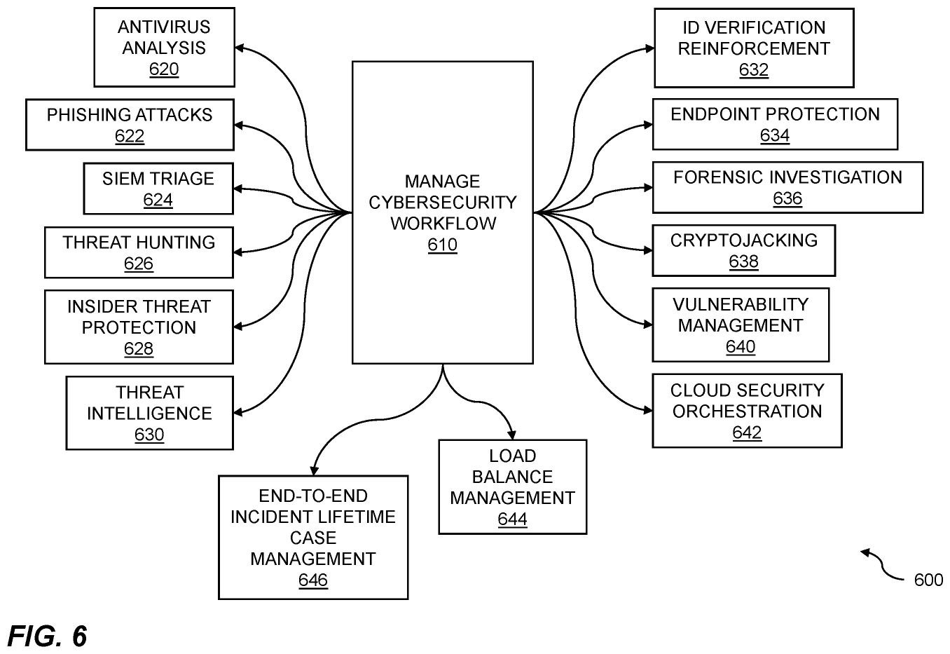

FIG. 6 is a flow diagram for cybersecurity workflow management. Information technology (IT) infrastructure comprises computing devices, storage devices, networks, perhaps personal devices, operating systems, cloud-based systems, and so on. Whether these IT elements are operated by an individual for personal use or by an organization in support of operations, all of the IT elements are nearly constant targets of malicious attacks from outside an organization. Worse yet, some of the attacks originate from within an organization. Cybersecurity management is based on cybersecurity case triage groupings. The triage groupings can include generating cybersecurity threat responses based on triaging threat protection application inputs into groupings. A plurality of network-connected cybersecurity threat protection applications is accessed. A plurality of inputs is received from the cybersecurity threat protection applications, wherein the plurality of inputs is initiated by one or more cybersecurity events. A computer platform is used to analyze metadata associated with the plurality of inputs from the cybersecurity threat protection applications. The inputs are triaged into groupings, based on the metadata. A cybersecurity threat response is generated, based on the groupings.

The diagram 600 includes cybersecurity management 610. Cybersecurity management can include prioritizing a variety of IT techniques for identifying threat risks, correcting identified risks, counteracting active threats, and so on. Cybersecurity management can be based on accessing a range of applications (discussed below) which can include antivirus software, access control, data encryption, network channel encryption, and the like. In embodiments, cybersecurity includes managing the plurality of threat protection applications for a data network. The techniques that can be used for cybersecurity management can be based on one or more workflows. The workflows, which can include cybersecurity tasks and commands, can automate various tasks associated with cybersecurity management. In embodiments, the managing cybersecurity can include graphical control of the plurality of cybersecurity threat protection applications. The graphical control can enable dragging and dropping of tasks, commands, and so on into a workflow. In other embodiments, the automation workflows can support dynamic swapping of cybersecurity threat protection applications. The workflows can support swapping-in or swapping-out one or more threat protection applications. The swapping-in and the swapping-out are enabled by a universal data layer (UDL). The UDL enables applications to be swapped without having to edit a workflow or create a new workflow to address the swapped-in application.

The diagram 600 includes antivirus analysis 620. Antivirus analysis can include virus detection, Trojan horse program detection, and so on. The analysis can include determining a source or vector of a virus, the actions taken by the virus, how to counter actions taken by the virus, to whom the virus might be in communication, etc. The antivirus analysis can be used to determine changes or updates to the virus, and how to better detect the virus before it can be deployed. The diagram 600 can include analysis of phishing attacks 622. Phishing is a form of attack that attempts to fraudulently obtain personal, sensitive, or private data and information. The data or information that is sought by a phishing attack can include personal information such as name, address, date of birth, telephone number, email address, and so on. The information can further include government-related information such as social security numbers, tax records, military service information, etc. The information can also include usernames and passwords to sensitive websites such as banks, brokerages, hospitals and health care providers, and the like. A phishing attack can purport to be from an entity known to a user by presenting the user with a legitimate looking webpage. However, links on the fraudulent page do not take the user to the legitimate site, but rather to a site designed to steal the victim's data.

The diagram 600 includes security information and event management (STEM) triage 624. SIEM, which combines the management of security information and security events, can provide analysis of security alerts, alarms, warnings, etc. in real time. The alerts that are analyzed can be generated by one or more of the plurality of cybersecurity threat protection applications, by network security hardware, and so on. The triage can be used to determine the severity of an alert, the scale or extent of the alert, the urgency of the alert, and the like. The diagram 600 includes threat hunting 626. Threat hunting can include techniques used to locate cybersecurity threats within a network, where the threats can elude detection using more common threat detection techniques. Threat hunting can include iteratively searching network-connected devices throughout a data network. Threat hunting can be used in addition to common cybersecurity techniques including firewalls for port blocking, intrusion detection, etc. The diagram 600 includes insider threat protection 628. Insider threats are among the most difficult threats to counter because they are perpetrated by people who have knowledge of the security techniques implemented by an organization. An insider threat attack can include physical damage to computing, data, and network systems; data breaches; and the like. Insider threats can result from overly permissive access to sensitive areas or data, lax firewall policies, etc. An insider attack can include moving sensitive data to another device within the organization—a lateral transfer.

The diagram 600 includes threat intelligence 630. Threat intelligence can include information associated with cybersecurity threats, used by an organization. The threat intelligence information can be associated with past security threats, current security threats, and threats likely to arise in the future. The information can be used by the organization to identify cybersecurity threats, to prevent the threats, and to prepare for inevitable threats that are likely to emerge in the future. The diagram 600 includes identity verification reinforcement 632. Identity verification can include techniques to verify that a person who has access to computing systems, data systems, networks, and so on that are associated with an enterprise, is in fact a real person. Identity verification can be based on physical documents such as a government issued identification documents. The diagram 600 can include endpoint protection 634. In a typical enterprise computing environment, individuals may try to use personal electronic devices to access the enterprise network. Such devices can include laptop computers, tablets, PDAs, smartphones, and the like. Such devices can pose a serious threat to an enterprise network because of operating systems which may not be updated, questionable applications which may be installed on the devices, etc. Endpoint protection can require that any device, including personal electronic devices, must meet certain standards prior to connection to the enterprise network. The standards can include approved devices, operating systems, applications, antivirus applications, virtual private network apps, etc.

The diagram 600 includes forensic investigation 636. Digital forensic investigation can include data recovery, data maintenance, and investigation of data and information that can be found on various digital devices. Digital forensic techniques can be applied for investigation of a variety of digital malfeasances including cybercrime. Forensic investigation techniques can be used to determine, track, and locate perpetrators of cybercrime. The diagram 600 includes the detection of cryptojacking 638. Cryptojacking can include hijacking of computers, servers, personal electronic devices, and so on for the purposes of mining cryptocurrency. The diagram 600 includes vulnerability management 640. Vulnerability management seeks to reduce risks to computing systems, data systems, networks, and so on by identifying, evaluating, correcting, and communicating vulnerabilities associated with the computing systems and the applications that are executed on the computing systems. The diagram 600 includes cloud security orchestration 642. Many individuals, and organizations such as businesses, hospitals, universities, and government agencies, use cloud services for processing, data storage, and other IT services. Cloud orchestration can manage relationships, interactions, and communications among computational workloads. The computational workloads can be associated with public cloud infrastructure and private cloud infrastructure. Cloud security orchestration can include imposing permissions and access oversight, and policy enforcement.

The diagram 600 includes load balance management 644. The load balance management can balance and adjust assignment of cybersecurity threats to one or more analysts. The load balance management attempts to assign a cybersecurity threat to a specific analyst who is best suited to handling and addressing the cybersecurity threat. If the caseload associated with the analyst is “heavy” or “full”, then one or more cases assigned to that analyst can be reassigned to one or more other analysts. In embodiments, the reassigning can include a re-triage of an existing SOC caseload. The re-triage results can be used to reassign one or more analysts determined to be capable of handling the cybersecurity threat. The diagram 600 includes end-to-end incident lifetime case management 646. An incident can include a virus outbreak, a distributed denial-of-service (DDOS) attack, and the like. Incident lifetime management can include identifying that an incident has occurred, notifying that the incident has occurred and escalating response to the incident, investigating and diagnosing the incident, resolving the incident, and recovering from the incident. Incident lifetime management can further include closing the incident.

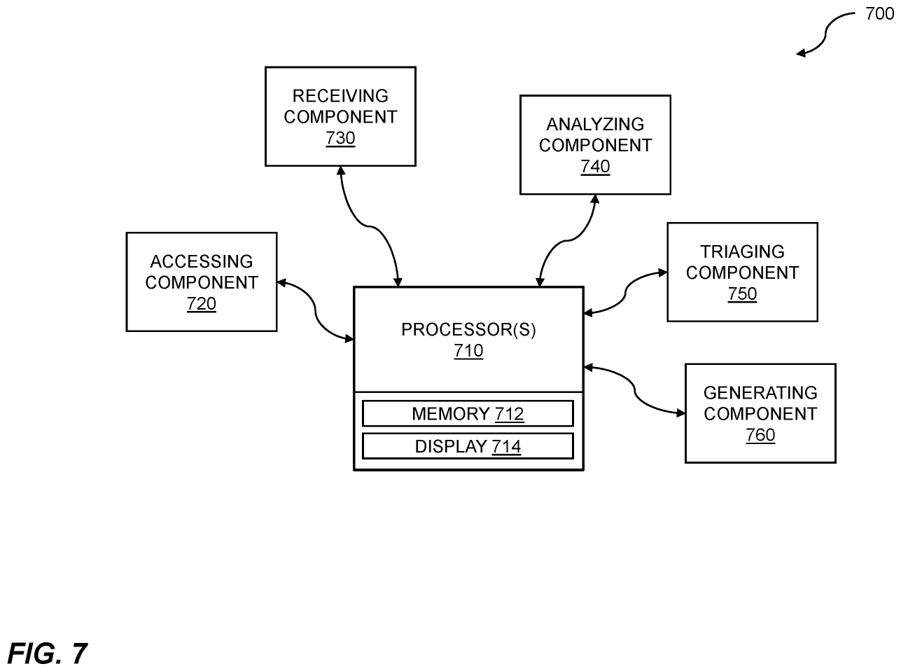

FIG. 7 is a system diagram for cybersecurity operations case triage groupings. Organizations of all sizes go to considerable and often painful lengths to secure their computing infrastructure and operations against cybersecurity threats. These organizations can include businesses, hospitals, government agencies, and schools, among many others. The detection of and response to all cybersecurity threats are critically important to each of these organizations, irrespective of their size. The organizations typically execute processing jobs based on data operations such as data manipulations, storage, security, transfers, and so on. The computing infrastructure that performs the computational operations comprises centrally located servers; widely distributed desktop computers and laptop computers; handheld electronic devices, etc. Many cybersecurity threats target and exploit hardware and software vulnerabilities, while other cybersecurity threats are based on “social engineering” techniques. These latter techniques include honeytraps, clickbait, phishing attacks, ransomware, distributed denial-of-service (DDoS) attacks, third-party software hacks, targeting cloud computing and storage vulnerabilities, and the like.

Cybersecurity management is based on cybersecurity operations case triage groupings. A plurality of network-connected cybersecurity threat protection applications is accessed. The cybersecurity threat protection applications can include antivirus applications, intrusion detection applications, and so on. A plurality of inputs is received from the cybersecurity threat protection applications, wherein the plurality of inputs is initiated by one or more cybersecurity events. The inputs from the cybersecurity threat protection applications can include alarms, warnings, messages, and the like. The cybersecurity events can be based on one or more detected cybersecurity threats and can include a previously experienced attack, a new attack, a combination of attacks, etc. A computer platform is used to analyze metadata associated with the plurality of inputs from the cybersecurity threat protection applications. The metadata can include a time and a frequency of cybersecurity threat protection application inputs, one or more techniques used to receive the application inputs, who or which tool provided the application inputs, etc. The inputs are triaged into groupings, based on the metadata. The groupings can establish modal commonality for the one or more cybersecurity events. A cybersecurity threat response is generated, based on the groupings. The response can include a workflow that can be developed to address, rectify, remediate, prevent, etc. the cybersecurity threat. The cybersecurity threat response can address various types of events such as a zero-day event.

The system 700 can include one or more processors 710 and a memory 712 which stores instructions. The memory 712 is coupled to the one or more processors 710, wherein the one or more processors 710 can execute instructions stored in the memory 712. The memory 712 can be used for storing instructions, one or more cybersecurity applications, log files, information associated with one or more data networks, a cybersecurity operations center caseload history, a supervisory workflow, data associated with a status, one or more actionable responses, and the like. Information associated with cybersecurity management can be rendered on a display 714 connected to the one or more processors 710. The display can comprise a television monitor, a projector, a computer monitor (including a laptop screen, a tablet screen, a netbook screen, and the like), a smartphone display, a mobile device, or another electronic display.

The system 700 can include an accessing component 720. The accessing component 720 can be used for accessing a plurality of network-connected cybersecurity threat protection applications. The applications can include applications for threat detection, assessment, and response management; web security; antivirus; dark web monitoring; security (“white hat”) testing; and other cybersecurity threat protection application capabilities. In embodiments, the cybersecurity threat protection application capabilities can include endpoint protection, anti-phishing protection, antivirus protection, firewall protection, man-in-the-middle protection, denial-of-service protection, distributed denial-of-service protection, and ransomware protection. The plurality of cybersecurity threat protection applications can include at least two different data management schemas. A data management schema can include an organization or collection of management techniques associated with data. The management techniques can include data storage, access control to data (e.g., access control list or ACL, role-based access), and so on.

The system 700 includes a receiving component 730. The receiving component 730 is configured to receive a plurality of inputs from the cybersecurity threat protection applications, wherein the plurality of inputs is initiated by one or more cybersecurity events. The plurality of inputs from the cybersecurity threat protection applications can include a signal, a flag, an SMS message, an email message, a graphical display rendered on a display such as display 714, a proposed action, a recommended technique, and so on. The receiving component can receive, across a cybersecurity network, one or more inputs associated with a new cybersecurity threat. The receiving notifications can include receiving status reports and updates from at least one of the plurality of cybersecurity threat protection applications. Notification from a cybersecurity threat protection application can include an indication of normal operation or other status of one or more processors, networks, and other information technology (IT) infrastructure. The received notifications can include an abnormal status such as high-volume incoming status data. The input status data from the one or more cybersecurity threat protection applications can include an indication of a potential, detected, or ongoing cybersecurity event or situation.

The input from the cybersecurity threat protection application can include data associated with an alert, a warning, etc. The input data can include device-related information. The device-related information can include a type of device such as a handheld device, a portable device, a personal device, a device provided by an organization, etc. The input data can include an event name, an application name, an event count, a category such as a low-level category, a source IP address and port, a destination IP address and port, a username, a magnitude, etc. The input data can include threat protection elements. The threat protection elements can include non-cybersecurity, network-related elements. These elements can provide additional information that can help pinpoint a source of a cybersecurity threat, a threat target, a priority level, etc. The non-cybersecurity, network-related elements can include information technology (IT) tool output, network configuration data, cybersecurity threat protection application metadata, network-related metadata, network client physical location data, network client internet protocol (IP) identification data, and user-entered data. The input data can further include information about the user of a device, a data service, and so on. The user information can include identifying information associated with the user; a user's role, status, and rank within an organization; user privileges such as access and security privileges; user location; and the like.

The system 700 can include an analyzing component 740. The analyzing component 740 can analyze, on a computer platform, metadata associated with the plurality of inputs from the cybersecurity threat protection applications. The computer platform can include a desktop computer, a laptop computer, a server, a blade server, a remote server, a cloud server, and so on. The metadata can include device information, device status such as company-owned or user-provided, user status, user rank, user location, user security clearance, etc. The device information can further include the device user, device owner, and the like. The device information can include an operating system such as Windows™, macOS™, or Chrome OS™ version; Android™, iOS™, or iPadOS™ version; etc. In embodiments, the information about a device and information about one or more users of the device can include impact score metadata. The impact score metadata can indicate a device “value” or criticality such as low, medium, or high. The impact score can reference a position of an individual such as production worker, manager, C-suite level, etc. The impact score can be weighted, where the weighting the impact score can be based on evaluation of the device, a user of the device, an owner of the device, and an asset.

The system 700 can include a triaging component 750. The triaging component 750 can triage the inputs into groupings, based on the metadata. The groupings can be based on individual users, class of user, and user role; device type such as computational device, networking device, or storage device; severity and impact; and so on. In embodiments, the triaging can determine commonality of threats among the plurality of inputs. The commonality of threats can include a targeted user group, virus warnings or similar alerts from two or more cybersecurity threat protection applications, targets of a distributed denial-of-service attack, etc. In embodiments, the triaging can confirm a true positive analysis of one or more of the plurality of inputs. The positive analysis can include detecting a previously experienced attack, a new attack type or mode, and the like. The triaging can be based on analysis. The analyzing can include analyzing patterns of behavior of an attack. In embodiments, the triage results can include an analysis of threat severity and threat complexity. The threat severity can be based on a qualitative assignment such as low, medium, or high; a numerical value or percentage; and so on. The threat severity can be based on exceeding a tolerance threshold.

The system 700 can include a generating component 760. The generating component 760 can generate a cybersecurity threat response, based on the groupings. A response can include starting a workflow to address the threat, initiating a device or access lockdown, commencing a threat eradication procedure, and so on. In embodiments, the response can be provided to a cybersecurity threat management entity. The cybersecurity threat management entity can include a human-based entity, a machine-based entity, and so on. In embodiments, the cybersecurity threat management entity can include a cybersecurity professional. More than one professional can be included. The one or more professionals can activate a workflow, initiate a cybersecurity process or policy, and the like. In other embodiments, the cybersecurity threat management entity can be a security orchestration automation and response (SOAR) application. The application can include an in-house application, a commercially available application, etc.

The generating a cybersecurity threat response can include generating a notification. The notification can be used to trigger a variety of responses. The generated response to a cybersecurity threat can include managing individual devices, groups of devices, or classes of devices coupled to a data network; individual users, user groups, or types of user; regions of a data network; and so on. The generating a response can include granting user access to an asset, denying access, isolating one or more devices, notifying security or law enforcement, and the like. The generating a response can include one or more tasks, procedures, protocols, workflows, techniques, etc., associated with cybersecurity. In embodiments, the generating a response to a cybersecurity threat can include managing one or more of antivirus analysis, phishing attack response, review, security information and event management (STEM) triage, threat hunting, insider threat protection, threat intelligence, identity verification reinforcement, endpoint protection, forensic investigation, cryptojacking, vulnerability, cloud security orchestration, and end-to-end incident lifecycle cases. The generating a response can include “white hat” testing such as penetration testing of one or more of networks, systems, devices, and so on. The white hat penetration testing can include white box testing, where a tester can have full access and knowledge of networks, systems, and so on. The white hat testing can further include black box testing (no access or knowledge), gray box testing (some access and knowledge), etc.

The generating a response can include simulating or emulating cybersecurity threats. Embodiments further include simulating cybersecurity threat scenarios by activating inputs associated with the plurality of cybersecurity threat protection applications. The simulation can be based on virtual activation, actual activation, and so on. In embodiments, the simulating virtually activates cybersecurity measures in a simulation mode. One or more devices coupled to a data network can be taken offline, placed in an isolated network such as a “security playpen”, etc. In other embodiments, the simulating actually activates cybersecurity measures in the data network. The actually activating cybersecurity measures in the data network can be accomplished using a variety of techniques such as activating outputs of one or more cybersecurity threat protection applications. Further embodiments include activating one or more data enrichment protocols for a threat, based on the data stimuli received from at least one of the plurality of cybersecurity threat protection applications. The data enrichment can be accomplished by enabling additional features of a cybersecurity threat application, activating additional applications, etc. In embodiments, the one or more data enrichment protocols can include accessing a website. The website can include a secure website. In embodiments, the accessing a website can enable additional information gathering for the threat.

In embodiments, the accessing, the receiving, the analyzing, the triaging, and the generating are converted to machine learning training data. The machine learning training data can be provided to a network such as a processing network. The network can include a neural network. The network can be trained to identify successes, deficiencies, and other parameters within the case triage groupings. Further embodiments include training a neural network using the machine learning training data. Once trained, the neural network can be used to examine inputs received from one or more cybersecurity threat protection applications, analyze triaged groupings, gauge performance of one or more previously generated responses, etc. Further embodiments include executing the analyzing, the triaging, and the generating on the neural network that was trained. The neural network can analyze large datasets comprising inputs received from the network-connected cybersecurity threat protection applications and can do so far faster than a human expert. The neural network can be used to identify threat response successes, deficiencies, and so on. Further embodiments can include developing a pedagogy plan for one or more analysts, such as analysts within a cohort of analysts staffing a security operations center or SOC. The pedagogy plan can include training and certification of analysts, analysis techniques, and so on. In embodiments, the pedagogy plan can be developed using a machine learning algorithm. The machine learning algorithm can identify cybersecurity threat response trends within historical data collected from the cybersecurity threat protection applications. The accessing, the receiving, the analyzing, the triaging, and the generating can be managed by a cybersecurity threat protection system. The cybersecurity threat protection system can be network-connected. In embodiments, the accessing, the receiving, the analyzing, the triaging, and the generating can be managed by a security orchestration, automation, and response (SOAR) system.

Disclosed embodiments include a computer program product embodied in a non-transitory computer readable medium for cybersecurity management, the computer program product comprising code which causes one or more processors to perform operations of: accessing a plurality of network-connected cybersecurity threat protection applications; receiving a plurality of inputs from the cybersecurity threat protection applications, wherein the plurality of inputs is initiated by one or more cybersecurity events; analyzing, on a computer platform, metadata associated with the plurality of inputs from the cybersecurity threat protection applications; triaging the inputs into groupings, based on the metadata; and generating a cybersecurity threat response, based on the groupings. Disclosed embodiments further include a computer system for cybersecurity comprising: a memory which stores instructions; one or more processors coupled to the memory wherein the one or more processors, when executing the instructions which are stored, are configured to: access a plurality of network-connected cybersecurity threat protection applications; receive a plurality of inputs from the cybersecurity threat protection applications, wherein the plurality of inputs is initiated by one or more cybersecurity events; analyze, on a computer platform, metadata associated with the plurality of inputs from the cybersecurity threat protection applications; triage the inputs into groupings, based on the metadata; and generate a cybersecurity threat response, based on the groupings.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited neither to conventional computer applications nor the programmable apparatus that run them. To illustrate: the embodiments of the presently claimed invention could include an optical computer, a quantum computer, an analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for cybersecurity management comprising:
accessing a plurality of network-connected cybersecurity threat protection applications;
receiving a plurality of inputs from the cybersecurity threat protection applications, wherein the plurality of inputs is initiated by one or more cybersecurity events;
analyzing, on a computer platform, metadata associated with the plurality of inputs from the cybersecurity threat protection applications;
triaging the inputs into groupings, based on the metadata; and
generating a cybersecurity threat response, based on the groupings.

2. The method of claim 1 wherein the groupings are based on a number of users experiencing the plurality of inputs.

3. The method of claim 2 wherein the number of users is matched against a threshold for the plurality of inputs.

4. The method of claim 3 wherein the threshold is based on a particular grouping.

5. The method of claim 3 wherein the threshold is set recursively for a particular grouping.

6. The method of claim 1 wherein the analyzing is based on parsing incoming traffic alerts from the cybersecurity threat protection applications.

7. The method of claim 1 wherein the groupings establish modal commonality for the one or more cybersecurity events.

8. The method of claim 1 wherein the triaging determines commonality of threats among the plurality of inputs.

9. The method of claim 1 wherein the cybersecurity threat response addresses a zero-day event.

10. The method of claim 1 wherein the triaging confirms a true positive analysis of one or more of the plurality of inputs.

11. The method of claim 1 further comprising mapping the plurality of inputs from the cybersecurity threat protection applications.

12. The method of claim 11 wherein the mapping enables categorization of the groupings.

13. The method of claim 12 wherein the categorization of the groupings modifies the triaging.

14. The method of claim 13 wherein the triaging that was modified triggers a modified cybersecurity threat response.

15. The method of claim 1 wherein the triaging confirms a true positive cybersecurity threat event.

16. The method of claim 1 further comprising mapping the metadata associated with the plurality of inputs from the cybersecurity threat protection applications.

17. The method of claim 16 wherein the mapping the metadata modifies the triaging.

18. The method of claim 1 wherein the accessing, the receiving, the analyzing, the triaging, and the generating are converted to machine learning training data.

19. The method of claim 18 further comprising training a neural network using the machine learning training data.

20. The method of claim 19 further comprising executing the analyzing, the triaging, and the generating on the neural network that was trained.

21. The method of claim 1 wherein the accessing, the receiving, the analyzing, the triaging, and the generating are managed by a security orchestration, automation, and response (SOAR) system.

22. A computer program product embodied in a non-transitory computer readable medium for cybersecurity management, the computer program product comprising code which causes one or more processors to perform operations of:
accessing a plurality of network-connected cybersecurity threat protection applications;
receiving a plurality of inputs from the cybersecurity threat protection applications, wherein the plurality of inputs is initiated by one or more cybersecurity events;
analyzing, on a computer platform, metadata associated with the plurality of inputs from the cybersecurity threat protection applications;
triaging the inputs into groupings, based on the metadata; and
generating a cybersecurity threat response, based on the groupings.

23. A computer system for cybersecurity management comprising:
a memory which stores instructions;
one or more processors coupled to the memory, wherein the one or more processors, when executing the instructions which are stored, are configured to:
access a plurality of network-connected cybersecurity threat protection applications;
receive a plurality of inputs from the cybersecurity threat protection applications, wherein the plurality of inputs is initiated by one or more cybersecurity events;
analyze, on a computer platform, metadata associated with the plurality of inputs from the cybersecurity threat protection applications;
triage the inputs into groupings, based on the metadata; and
generate a cybersecurity threat response, based on the groupings.
